(19) United States
(12) Patent Application Publication
(10) Pub. No.: US 2019/0129570 A1
(43) Pub. Date: May 2, 2019

(54) ANTI-MISTOUCH APPARATUS AND METHOD OF FLEXIBLE SCREEN

(71) Applicants: BOE Technology Group Co., Ltd., Beijing (CN); Ordos Yuansheng Optoelectronics Co., Ltd., Inner Mongolia (CN)

(72) Inventors: Lina Liu, Beijing (CN); Hualing Yang, Beijing (CN)

(21) Appl. No.: 15/983,451

(22) Filed: May 18, 2018

(30) Foreign Application Priority Data
Oct. 27, 2017 (CN) 201711023516.8

(51) Int. Cl. G06F 3/041

(52) U.S. Cl. CPC G06F 3/0418; G06F 3/044; G06F 2203/04102

(57) ABSTRACT

The present disclosure discloses an anti-mistouch apparatus and method of a flexible screen. The flexible screen comprises N touch driving lines and M touch sensing lines intersecting with the N touch driving lines, where N and M are integers greater than 1. The apparatus comprises a detection circuit configured to detect a bending state of the flexible screen; and a driving conversion circuit connected to the detection circuit and configured to determine a display surface and a non-display surface of the flexible screen according to the bending state of the flexible screen, control at least one touch driving line included in the display surface to enter an operating state, and control at least one touch driving line included in the non-display surface to enter a non-operating state.

### CROSS-REFERENCE TO RELATED APPLICATION(S)

This application claims priority to the Chinese Patent Application No. 2017110235168, filed on Oct. 27, 2017, which is incorporated herein by reference in its entirety.

### TECHNICAL FIELD

The present disclosure relates to the field of display technology, and more particularly, to an anti-mistouch apparatus of a flexible screen, a flexible screen, an electronic device, and an anti-mistouch method of a flexible screen.

### BACKGROUND

With the advent and development of display technology, flexible display has become the trend of display development in the future. Flexible screens which can be bent are widely applied on mobile phones and tablets. A user may bend a flexible screen according to his/her own requirements. For example, the flexible screen may be bent by 180 degrees, i.e., being folded, which can realize excellent user experience.

### SUMMARY

According to an aspect of the present disclosure, there is proposed an anti-mistouch apparatus of a flexible screen, wherein the flexible screen comprises N touch driving lines and M touch sensing lines intersecting with the N touch driving lines, where N and M are integers greater than 1, the apparatus comprising:

a detection circuit configured to detect a bending state of the flexible screen; and

a driving conversion circuit connected to the detection circuit and configured to determine a display surface and a non-display surface of the flexible screen according to the bending state of the flexible screen, control at least one touch driving line included in the display surface to enter an operating state, and control at least one touch driving line included in the non-display surface to enter a non-operating state.

In an embodiment, the driving conversion circuit is configured to connect the at least one touch driving line included in the non-display surface to a first driving chip, and the first driving chip is configured to provide a first driving signal to the at least one touch driving line included in the non-display surface through the driving conversion circuit so that the at least one touch driving line included in the non-display surface enters a non-operating state.

In an embodiment, the driving conversion circuit is further configured to connect the at least one touch driving line included in the display surface to a second driving chip, and the second driving chip is configured to provide a second driving signal to the at least one touch driving line included in the display surface through the driving conversion circuit so that the at least one touch driving line included in the display surface enters an operating state.

In an embodiment, the first driving signal is a preset level signal.

In an embodiment, the second driving signal is a pulse signal.

In an embodiment, the M touch sensing lines intersect with the N touch driving lines to form M×N sensor nodes, and the detection circuit is configured to acquire position information of each of the sensor nodes.

In an embodiment, the detection circuit is further configured to determine whether a fault condition occurs in the flexible screen according to the position information of each of the sensor nodes, and when it is determined that a fault condition occurs, determine the bending position of the flexible screen according to the fault condition.

According to another aspect of the present disclosure, there is proposed a flexible screen, comprising the anti-mistouch apparatus of a flexible screen according to claim 1.

According to yet another aspect of the present disclosure, there is proposed an electronic device, comprising the flexible screen according to claim 8.

According to a further aspect of the present disclosure, there is proposed an anti-mistouch method of a flexible screen, wherein the flexible screen comprises N touch driving lines and M touch sensing lines intersecting with the N touch driving lines, where N and M are integers greater than 1, the method comprising:

detecting a bending state of the flexible screen;

determining a display surface and a non-display surface of the flexible screen according to the bending state of the flexible screen;

controlling at least one touch driving line included in the display surface to enter an operating state; and

controlling at least one touch driving line included in the non-display surface to enter a non-operating state.

In an embodiment, controlling at least one touch driving line included in the non-display surface to enter a non-operating state comprises:

connecting the at least one touch driving line included in the non-display surface to a first driving chip,

wherein the first driving chip is configured to provide a first driving signal to the at least one touch driving line included in the non-display surface so that the at least one touch driving line included in the non-display surface enters a non-operating state.

In an embodiment, controlling at least one touch driving line included in the display surface to enter an operating state comprises:

connecting the at least one touch driving line included in the display surface to a second driving chip,

wherein the second driving chip is configured to provide a second driving signal to the at least one touch driving line included in the display surface so that the at least one touch driving line included in the display surface enters an operating state.

In an embodiment, the first driving signal is a preset level signal.

In an embodiment, the second driving signal is a pulse signal.

In an embodiment, the M touch sensing lines intersect with the N touch driving lines to form M×N sensor nodes,

wherein detecting a bending state of the flexible screen comprises:

acquiring position information of each of the sensor nodes.

In an embodiment, detecting a bending state of the flexible screen further comprises:

determining whether a fault condition occurs in the flexible screen according to the position information of each of the sensor nodes, and when it is determined that a fault condition occurs, determining the bending position of the flexible screen according to the fault condition.

### BRIEF DESCRIPTION OF THE DRAWINGS

FIG. 1 is a block diagram of an anti-mistouch apparatus of a flexible screen according to an embodiment of the present disclosure;

FIG. 2 is a diagram of a flexible screen in a bending state when the flexible screen is bent by 180 degrees according to an embodiment of the present disclosure;

FIG. 3 is a diagram of a distribution of touch driving lines and touch sensing lines of a flexible screen according to an embodiment of the present disclosure;

FIG. 4 is a structural diagram of an anti-mistouch apparatus of a flexible screen according to an embodiment of the present disclosure;

FIG. 5 is a diagram of a fault condition occurring when a flexible screen is bent according to an embodiment of the present disclosure; and

FIG. 6 is a flowchart of an anti-mistouch method of a flexible screen according to an embodiment of the present disclosure.

### DETAILED DESCRIPTION

Embodiments of the present disclosure will be described in detail below. Examples of the embodiments are illustrated in the accompanying drawings, throughout which the same or similar reference signs denote the same or similar elements or elements having the same or similar functions. The embodiments described below with reference to the accompanying drawings are exemplary and are intended to explain the present disclosure, but should not be construed as limiting the present disclosure.

In the related art, when a flexible screen is bent by 180 degrees, it is easy to cause a mistouch on a portion which needs not to be displayed. The present disclosure aims to solve to some extent at least one of the technical problems in the related art. For this, an object of the present disclosure is to propose an anti-mistouch apparatus of a flexible screen, which can effectively avoid a mistouch on the portion which needs not to be displayed. Another object of the present disclosure is to propose a flexible screen. Yet another object of the present disclosure is to propose an electronic device. Another object of the present disclosure is to propose an anti-mistouch method of a flexible screen.

An electronic device, a flexible screen, and an anti-mistouch apparatus and method thereof according to the embodiments of the present disclosure will be described below with reference to the accompanying drawings.

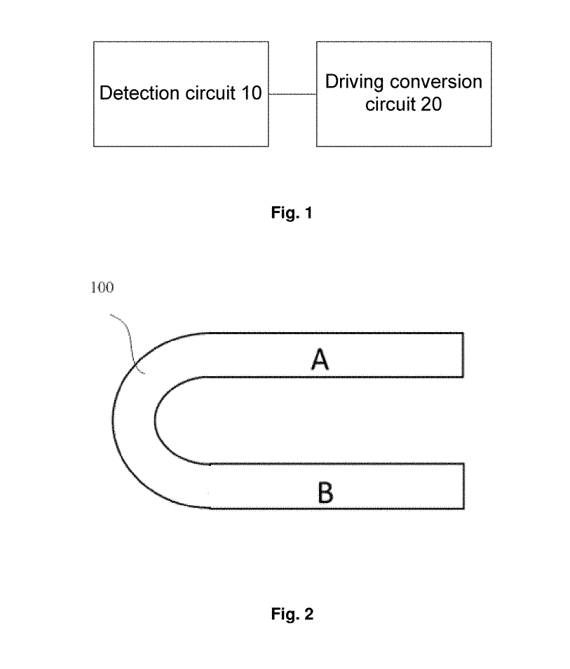

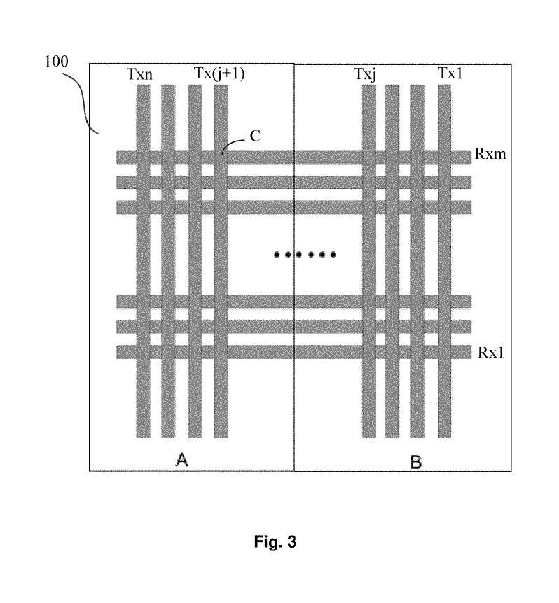

FIG. 1 is a block diagram of an anti-mistouch apparatus of a flexible screen according to an embodiment of the present disclosure. As shown in FIG. 3, the flexible screen 100 comprises N touch driving lines Tx and M touch sensing lines Rx intersecting with the N touch driving lines Tx, where N and M are integers greater than 1. Specifically, the N touch driving lines Tx may be longitudinally disposed, and the M touch sensing lines Rx may be laterally disposed; however, the embodiments of the present disclosure are not limited thereto.

The M touch sensing lines intersect with the N touch driving lines to form M×N sensor nodes C, and each of the M×N sensor nodes C has mutual capacitance. The touch driving lines Tx may receive a driving signal, and charges of touch sensors may be sampled through the touch sensing lines Rx. A position where a touch input occurs is determined by sensing a change in voltages charged to the sensor nodes C before and after the touch input is sensed. In other words, when the voltages charged to the sensor nodes C are sensed, a driving pulse is applied to the touch driving lines Tx, and the change in the voltages of the sensor nodes C is sampled in synchronization with the driving pulse through the touch sensing lines Rx.

As shown in FIG. 1, the anti-mistouch apparatus comprises a detection circuit 10 and a driving conversion circuit 20.

The detection circuit 10 is configured to detect a bending state of the flexible screen 100. For example, the bending state of the flexible screen 100 may comprise information of the flexible screen 100 such as a bending angle, a bending position etc. As shown in FIG. 2, illustrated is a diagram of the flexible screen 100 when the flexible screen 100 is bended by 180 degrees. The driving conversion circuit 20 is connected to the detection circuit 10. The driving conversion circuit 20 is configured to determine a display surface A and a non- display surface B of the flexible screen 100 according to the bending state of the flexible screen 100, and control at least one touch driving line Tx included in the display surface A to enter an operating state so that the display surface A receives a touch operation, and control at least one touch driving line Tx included in the non-display surface B to enter a non-operating state so that the non-display surface B stops receiving the touch operation.

For example, the display surface A and the non-display surface B of the flexible screen 100 may be determined in conjunction with a position of a front camera, that is, a surface of the flexible screen 100 which is in the same plane as that of the front camera may be used as the display surface A, and a surface of the flexible screen 100 which is not in the same plane as that of the front camera may be used as the non-display surface B. As shown in FIG. 2, after the flexible screen 100 is bent by 180 degrees, the front camera faces upwards, and therefore the display surface A faces upwards and the non-display surface B faces downwards. It should be illustrated that the embodiments of the present disclosure are not limited thereto.

After the display surface A and the non-display surface B of the flexible screen 100 are determined, the driving conversion circuit 20 may determine at least one touch driving line Tx included in the display surface A, for example, touch driving lines Tx(j+1) to Txn included in the display surface A, as shown in FIG. 3; and determine at least one touch driving line Tx included in the non-display surface B, for example, touch driving lines Tx1 to Txj included in the non-display surface B, as shown in FIG. 3.

Then, the driving conversion circuit 20 may control the touch driving lines Tx(j+1) to Txn to be in an operating state, for example, the touch driving lines Tx(j+1) to Txn are connected to a chip capable of providing a driving pulse. In this way, a change in the voltages of the sensor nodes C formed by the touch driving lines Tx(j+1) to Txn intersecting with the M touch sensing lines can be sampled through the M touch sensing lines, thereby realizing touch detection on the display surface A.

The driving conversion circuit 20 may control the touch driving lines Tx1 to Txj to be in a non-operating state, for example, the touch driving lines Tx1 to Txj are not connected to the chip capable of providing a driving pulse. In this way, as the driving pulse is not provided to the touch driving lines Tx1 to Txj, the voltage of the sensor nodes C formed by the touch driving lines Tx1 to Txj intersecting with the M touch sensing lines does not change with the trigger input, and therefore touch detection may not be performed on the non-display surface B.

Therefore, with the anti-mistouch apparatus of a flexible screen according to the embodiments of the present disclosure, the detection circuit detects a bending state of the flexible screen, and the driving conversion circuit determines a display surface and a non-display surface of the flexible screen according to the bending state of the flexible screen, and controls at least one touch driving line included in the display surface to enter an operating state, so that the display surface receives a touch operation, and controls at least one touch driving line included in the non-display surface to enter a non-operating state, so that the non-display surface stops receiving the touch operation. In this way, it can effectively avoid a mistouch on a portion which needs not to be displayed. Further, the existing screen production process is not changed and no extra production cost is added for the apparatus, and the apparatus has a simple circuit and is easy to implement.

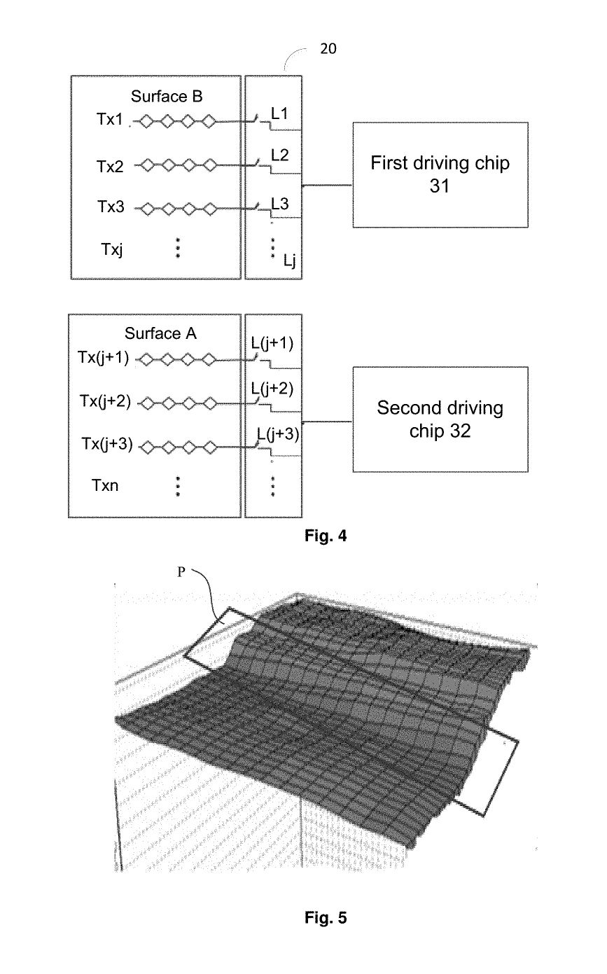

Further, according to an embodiment of the present disclosure, FIG. 4 is a structural diagram of an anti-mistouch apparatus of a flexible screen according to an embodiment of the present disclosure. As shown in FIG. 4, the driving conversion circuit 20 is configured to connect the at least one touch driving line Tx included in the non-display surface B to a first driving chip 31. The first driving chip 31 provides a first driving signal to the at least one touch driving line Tx included in the non-display surface B through the driving conversion module 20, so that the at least one touch driving line Tx included in the non-display surface B enters a non-operating state.

Further, as shown in FIG. 4, the driving conversion circuit 20 is further configured to connect the at least one touch driving line Tx included in the display surface A to a second driving chip 32. The second driving chip 32 also provides a second driving signal to the at least one touch driving line Tx included in the display surface A through the driving conversion circuit 20, so that the at least one touch driving line Tx included in the display surface A enters an operating state.

In an embodiment, the first driving signal may be a preset level signal, that is, the first driving signal is a direct current signal, and the second driving signal may be a pulse signal. The first driving chip 31 and the second driving chip 32 may be a first display chip and a second display chip of the flexible screen 100 respectively. In other words, the display of the flexible screen 100 may be controlled by the two display chips, wherein the second display chip may control the display of the display surface A, and the first display chip may control the display of the non-display surface B.

That is, the N touch driving lines Tx may be divided into two groups, i.e., a first group and a second group, according to the bending state of the flexible screen 100, wherein touch driving lines Tx(j+1) to Txn of the first group are included in the display surface A, and touch driving lines Tx(j+1) to Txn of the second group are included in the non-display surface B.

As shown in FIGS. 3 and 4, the driving conversion circuit 20 may connect the second driving chip 32 (for example, the second display chip) to the touch driving lines Txn to Tx(j+1), and connect the first driving chip 31 (for example, the first display chip) to the touch driving lines Tx1-Txj. When the screen is normally displayed, the display chip outputs the second driving signal, i.e., a continuous pulse signal. When the screen is not displayed, the display chip outputs the first driving signal, i.e., a direct current signal.

Therefore, when the flexible screen is bent, the screen of the display surface A is normally displayed, the screen of the non-display surface B is not displayed, the second display chip inputs the second driving signal, for example, a pulse signal, to the touch driving lines Txn to Tx(j+1) in a time division manner, each of the touch driving lines Txn to Tx(j+1) receives the pulse signal in turn, and the touch sensing lines Rx may also receive the pulse signal synchronously, so that a position where the touch occurs may be detected by sampling the voltages of the touch sensing lines Rx. The first display chip may also input the first driving signal, for example, a direct current signal, to the touch driving lines Tx1 to Txj in a time division manner or simultaneously. As the first driving signal is a direct current signal, i.e., there is no driving, the touch sensing lines Rx cannot receive a signal and touch detection cannot be performed. In this way, it solves the problem that a mistouch may occur on the non-display surface B in the bending state.

More specifically, as shown in FIG. 4, the second driving chip 32 may be connected to (n-j) touch driving lines Txn to Tx(j+1) through (n-j) paths Ln to L(j+1), wherein the (n-j) paths may be controlled to be turned on in turn to input the pulse signal to the touch driving lines Txn to Tx(j+1) in a time division manner. The first driving chip 31 may be connected to j touch driving lines Tx1 to Txj through j paths L1 to Lj, wherein the j paths may be controlled to be turned on in turn to input the direct current signal to the touch driving lines Tx1 to Txj in a time division manner.

Therefore, the anti-mistouch apparatus according to the embodiments of the present disclosure can avoid a touch on the non-display surface after the flexible screen enters the bending state without changing the flexible screen production process and without adding an extra manufacturing cost, and the anti-mistouch apparatus according to the embodiments of the present disclosure has a simple circuit.

In addition, the anti-mistouch apparatus according to the embodiments of the present disclosure may be integrated into a touch chip, a timing thereof may be changed through software in real time, and it is convenient to debug the anti- mistouch apparatus.

Specifically, according to an embodiment of the present disclosure, M touch sensing lines Rx intersect with N touch driving lines Tx to form M×N sensor nodes C, and the detection circuit 10 is configured to acquire position information of each of the sensor nodes C, and determine whether a fault condition occurs according to the position information of each of the sensor nodes C, and when it is determined that a fault condition occurs, determine a bending position of the flexible screen 100 according to the fault condition.

It should be illustrated that, when the flexible screen 100 is not bent, the M×N sensor nodes C are on the same plane. At this time, the position information of the M×N sensor nodes C is, for example, initial coordinates with respect to coordinates of the origin. When the flexible screen 100 is bent, the M×N sensor nodes C are not on the same plane. At this time, position information of a part of the sensor nodes C changes with respect to the coordinates of the origin. Thereby, it can be determined whether a fault condition occurs by comparing the acquired coordinates with the initial coordinates. For example, if a difference between the acquired coordinates and the initial coordinates exceeds a preset threshold, it is determined that a fault condition occurs.

Specifically, when the flexible screen 100 is bent by, for example, 180 degrees, anti-mistouch control is performed. That is, when the flexible screen 100 is bent, the position information of the sensor nodes C in the flexible screen 100, i.e., rawdata data, may change at the bending position. As shown in FIG. 5, an obvious fault condition occurs in the position information of the sensor nodes C at the bending position P. When the detection circuit 10 detects that a fault condition occurs in the rawdata data, the driving conversion circuit 20 performs the control according to the embodiments described above.

Therefore, the anti-mistouch apparatus according to the embodiments of the present disclosure can effectively avoid a touch on a non-display portion of the flexible screen when the flexible screen is bent by 180 degrees, and when the bending state is detected, the touch driving lines Tx are driven by the display chip. In this way, an effective touch state of the folded screen is achieved without changing the screen production process, and the screen production cost is saved.

Based on the anti-mistouch apparatus of a flexible screen according to the embodiments described above, the present disclosure further provides a flexible screen including the anti-mistouch apparatus of a flexible screen according to the embodiments described above.

According to the flexible screen according to the embodiments of the present disclosure, the anti-mistouch apparatus can effectively avoid a mistouch on a portion which needs not to be displayed. Further, the existing screen production process is not changed and no extra production cost is added for the apparatus, and the apparatus has a simple circuit and is easy to implement.

In addition, the present disclosure further proposes an electronic device including the flexible screen according to the embodiments described above. The electronic device may be a mobile phone, a tablet or a wearable device etc.

According to the electronic device according to the embodiments of the present disclosure, it can effectively avoid a mistouch on a portion which needs not to be displayed. Further, the existing screen production process is not changed and no extra production cost is added for the apparatus, and the apparatus has a simple circuit and is easy to implement.

In correspondence to the anti-mistouch apparatus of a flexible screen according to the several embodiments described above, the embodiments of the present disclosure further provide an anti-mistouch method of a flexible screen. As the anti-mistouch method of a flexible screen according to the embodiment of the present disclosure corresponds to the anti-mistouch apparatus of a flexible screen according to the embodiments described above, the implementations of the anti-mistouch apparatus of a flexible screen are also applicable to the anti- mistouch method of a flexible screen according to the present embodiment, and will not be repeated in detail in the present embodiment.

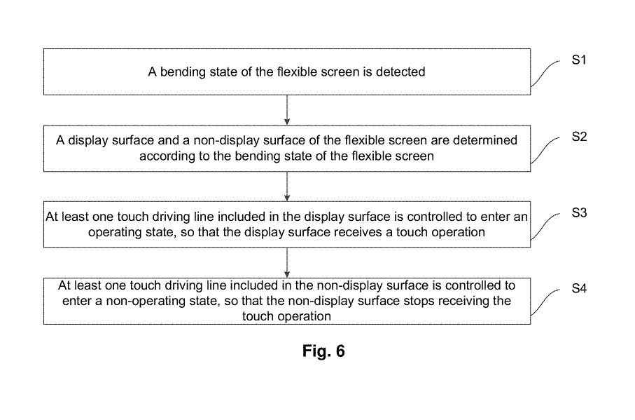

FIG. 6 is a flowchart of an anti-mistouch method according to an embodiment of the present disclosure. The flexible screen comprises N touch driving lines and M touch sensing lines intersecting with the N touch driving lines, where N and M are integers greater than 1. As shown in FIG. 6, the anti-mistouch method comprises the following steps.

In S1, a bending state of the flexible screen is detected.

In S2, a display surface and a non-display surface of the flexible screen are determined according to the bending state of the flexible screen.

In S3, at least one touch driving line included in the display surface is controlled to enter an operating state, so that the display surface receives a touch operation.

In S4, at least one touch driving line included in the non-display surface is controlled to enter a non-operating state, so that the non-display surface stops receiving the touch operation.

According to an embodiment of the present disclosure, step S4 of controlling at least one touch driving line included in the non-display surface to enter a non-operating state comprises:

connecting the at least one touch driving line included in the non-display surface to a first driving chip.

The first driving chip provides a first driving signal to the at least one touch driving line included in the non-display surface so that the at least one touch driving line included in the non-display surface enters the non-operating state.

According to an embodiment of the present disclosure, step S3 of controlling the at least one touch driving line included in the display surface to enter an operating state comprises:

connecting the at least one touch driving line included in the display surface to a second driving chip.

The second driving chip provides a second driving signal to the at least one touch driving line included in the display surface so that the at least one touch driving line included in the display surface enters the operating state.

According to an embodiment of the present disclosure, the M touch sensing lines in the flexible screen intersect with the N touch driving lines to form M×N sensor nodes. Step S1 of detecting a bending state of the flexible screen comprises:

acquiring location information of each of the sensor nodes; and

determining whether a fault condition occurs in the flexible screen according to the position information of each of the sensor nodes, and when it is determined that a fault condition occurs, determining a bending position of the flexible screen according to the fault condition.

With the anti-mistouch method of a flexible screen according to the embodiments of the present disclosure, a bending state of the flexible screen is detected, a display surface and a non-display surface of the flexible screen are determined according to the bending state of the flexible screen, at least one touch driving line included in the display surface is controlled to enter an operating state, so that the display surface receives a touch operation, and at least one touch driving line included in the non-display surface is controlled to enter a non-operating state, so that the non-display surface stops receiving the touch operation. In this way, it can effectively avoid a mistouch on a portion which needs not to be displayed. Further, the existing screen production process is not changed and no extra production cost is added for the method, the apparatus has a simple circuit and the method is easy to implement.

In the description of the present disclosure, it is to be understood that orientation or positional relationships indicated by the terms “center”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, “circumferential” etc. are based on the orientation or positional relationships shown in the accompanying drawings, and are merely for the convenience of describing the present disclosure and simplifying the description, but do not indicate or suggest that the indicated apparatus or element must have a particular orientation, or must be constructed and operated in a particular orientation, and therefore should not be construed as limiting the present disclosure.

Furthermore, the terms “first” and “second” are used for descriptive purposes only, and are not to be construed as indicating or implying relative importance or implicitly indicating a number of indicated technical features. Thus, features defined by “first” and “second” may explicitly or implicitly indicate that least one of the features is included. In the description of the present disclosure, “plurality” means at least two, such as two, three, etc., unless explicitly and specifically defined otherwise.

In the present disclosure, the terms “install,” “connect with,” “connect to,” “fix,” etc. shall be understood in a broad sense unless specifically defined or stipulated otherwise. For example, they may be fixed connections, or detachable connections, or integral connections; or may be mechanical connections or electrical connections; or may be direct connections, or indirect connections through an intermediary; or may be internal connections between two elements or interactions between two elements, unless explicitly defined otherwise. Those of ordinary skill in the art can understand the specific meanings of the above terms in the present disclosure according to specific conditions.

In the present disclosure, unless specifically stipulated and defined otherwise, the first feature “above” or “below” the second feature may be that the first feature and the second feature are in direct contact, or that the first feature and the second feature are in indirect contact via an intermediary. Further, the first feature “above”, “on” and “on top of” the second feature may be that the first feature is directly above or diagonally above the second feature, or may simply indicate that the first feature is higher than the second feature in height. The first feature “under”, “below” and “beneath” the second feature may be that the first feature is directly below or diagonally below the second feature, or may simply indicate that the first feature is lower than the second feature.

In the description of the present specification, the description referring to the terms “one embodiment”, “some embodiments”, “an example”, “a specific example”, or “some examples” etc. means that a specific feature, structure, material or characteristics described in conjunction with the embodiment or example is included in at least one embodiment or example of the present disclosure. In the present specification, schematic expressions of the above terms do not necessarily have to refer to the same embodiment or example. Furthermore, the specific feature, structure, material, or characteristics described may be combined in any suitable manner in any one or more embodiments or examples. In addition, those skilled in the art can combine and merge different embodiments or examples described in the present specification and features in different embodiments or examples without conflicting with each other.

Although the embodiments of the present disclosure have been shown and described above, it can be understood that the above embodiments are exemplary and are not to be construed as limiting the present disclosure. Those of ordinary skill in the art can make changes, modifications, substitutions and variations to the above embodiments within the scope of the present disclosure.

I/We claim:

1. An anti-mistouch apparatus of a flexible screen, wherein the flexible screen comprises N touch driving lines and M touch sensing lines intersecting with the N touch driving lines, where N and M are integers greater than 1, the apparatus comprising:
a detection circuit configured to detect a bending state of the flexible screen; and
a driving conversion circuit connected to the detection circuit and configured to determine a display surface and a non-display surface of the flexible screen according to the bending state of the flexible screen, control at least one touch driving line included in the display surface to enter an operating state, and control at least one touch driving line included in the non-display surface to enter a non- operating state.

2. The anti-mistouch apparatus of a flexible screen according to claim 1, wherein the driving conversion circuit is configured to connect the at least one touch driving line included in the non-display surface to a first driving chip, and the first driving chip is configured to provide a first driving signal to the at least one touch driving line included in the non-display surface through the driving conversion circuit so that the at least one touch driving line included in the non-display surface enters a non-operating state.

3. The anti-mistouch apparatus of a flexible screen according to claim 1, wherein the driving conversion circuit is further configured to connect the at least one touch driving line included in the display surface to a second driving chip, and the second driving chip is configured to provide a second driving signal to the at least one touch driving line included in the display surface through the driving conversion circuit so that the at least one touch driving line included in the display surface enters an operating state.

4. The anti-mistouch apparatus of a flexible screen according to claim 2, wherein the first driving signal is a preset level signal.

5. The anti-mistouch apparatus of a flexible screen according to claim 3, wherein the second driving signal is a pulse signal.

6. The anti-mistouch apparatus of a flexible screen according to claim 1, wherein the M touch sensing lines intersect with the N touch driving lines to form M×N sensor nodes, and the detection circuit is configured to acquire position information of each of the sensor nodes.

7. The anti-mistouch apparatus of a flexible screen according to claim 6, wherein the detection circuit is further configured to determine whether a fault condition occurs in the flexible screen according to the position information of each of the sensor nodes, and when it is determined that a fault condition occurs, determine the bending position of the flexible screen according to the fault condition.

8. A flexible screen, comprising the anti-mistouch apparatus of a flexible screen according to claim 1.

9. An electronic device, comprising the flexible screen according to claim 8.

10. An anti-mistouch method of a flexible screen, wherein the flexible screen comprises N touch driving lines and M touch sensing lines intersecting with the N touch driving lines, where N and M are integers greater than 1, the method comprising:
detecting a bending state of the flexible screen;
determining a display surface and a non-display surface of the flexible screen according to the bending state of the flexible screen;
controlling at least one touch driving line included in the display surface to enter an operating state; and
controlling at least one touch driving line included in the non-display surface to enter a non-operating state.

11. The anti-mistouch method of a flexible screen according to claim 10, wherein controlling at least one touch driving line included in the non-display surface to enter a non-operating state comprises:
connecting the at least one touch driving line included in the non-display surface to a first driving chip,
wherein the first driving chip is configured to provide a first driving signal to the at least one touch driving line included in the non-display surface so that the at least one touch driving line included in the non-display surface enters a non-operating state.

12. The anti-mistouch method of a flexible screen according to claim 10, wherein controlling at least one touch driving line included in the display surface to enter an operating state comprises:
connecting the at least one touch driving line included in the display surface to a second driving chip,
wherein the second driving chip is configured to provide a second driving signal to the at least one touch driving line included in the display surface so that the at least one touch driving line included in the display surface enters an operating state.

13. The anti-mistouch method of a flexible screen according to claim 11, wherein the first driving signal is a preset level signal.

14. The anti-mistouch method of a flexible screen according to claim 12, wherein the second driving signal is a pulse signal.

15. The anti-mistouch method of a flexible screen according to claim 10, wherein the M touch sensing lines intersect with the N touch driving lines to form M×N sensor nodes,
wherein detecting a bending state of the flexible screen comprises:
acquiring position information of each of the sensor nodes.

16. The anti-mistouch method of a flexible screen according to claim 15, wherein detecting a bending state of the flexible screen further comprises:
determining whether a fault condition occurs in the flexible screen according to the position information of each of the sensor nodes, and when it is determined that a fault condition occurs, determining the bending position of the flexible screen according to the fault condition.
